(19) United States
(12) Patent Application Publication
(10) Pub. No.: US 2014/0372919 A1
(43) Pub. Date: Dec. 18, 2014

(54) METHOD, APPARATUS AND MOBILE TERMINAL FOR EDITING AN IMAGE

(71) Applicant: BEIJING KINGSOFT INTERNET SECURITY SOFTWARE CO., LTD, Beijing (CN)

(72) Inventors: Ping FAN, Beijing (CN); Ming XU, Beijing (CN)

(21) Appl. No.: 14/304,818

(22) Filed: Jun. 13, 2014

(30) Foreign Application Priority Data
Jun. 17, 2013 (CN) 201310240093.0

(51) Int. Cl. G06F 3/0481; G06F 3/0484

(52) U.S. Cl. CPC G06F 3/04817; G06F 3/04842
USPC 715/765

(57) ABSTRACT

A method and an apparatus facilitate a user to edit a layout of images, thereby enhancing user experience. The method (a) provides an interface for editing an image, in which an image to be edited is displayed; (b) displays at least one layout template icon corresponding to at least one layout template in the interface, wherein the layout template icon is displayed separated from the image to be edited without overlapping; (c) receives an instruction that a user selects a layout template through a layout template icon; and (d) changes the layout of the image to be edited according to the selected layout template. The present invention can be used in image processing applications.

### CROSS REFERENCE TO RELATED APPLICATIONS

The present application is related to and claims priority of Chinese patent application, serial no. 201310240093.0, filed on Jun. 17, 2013. The disclosure of the Chinese patent application is hereby incorporated by reference in its entirety.

### BACKGROUND OF THE INVENTION

1. Field of the Invention

The present disclosure relates to image processing techniques. In particular, the present disclosure relates to a method, an apparatus and a mobile terminal for editing an image.

2. Discussion of the Related Art

In order to let users share multiple images on the internet with ease and to avoid monotony in content and visual impact for each image, image editing software provides the function of combining images. For example, such a combined image may be a partially overlapping or a non-overlapping combination of multiple images. The combined image may be a complete image, or cropped from a complete image.

Currently, editing software already provides the function for editing the layout of a combined image, such as changing position, size or shape of each included image in the combined image. At present, the function for editing the layout of a combined image can be realized in two ways. In one way, after a combined image is generated, a user may modify the layout of the combined image by leafing through a number of layout configurations one by one until a satisfactory layout is found. In the other way, the editing software may provide a selection interface for the user to select from a number of layouts. After the selection, the selection interface is withdrawn and the user is returned to an interface displaying the combined image. The user may then check the combined image with the selected layout.

The inventor of the present invention recognizes the following disadvantage in the prior art. With respect to leafing through layout options, a user may have to leaf through many options before a satisfactory layout is found. With respect to a dedicated interface for selecting layouts, the user cannot check the modified combined image in real time. In fact, the user may have to alternate between the selection interface and the display interface multiple times to chance upon a satisfactory layout. The required operations are tedious and thus result in a poor user experience.

### SUMMARY

The present disclosure provides a method for editing an image. The method may facilitate the editing operations, and may improve user experience. The present disclosure may also provide (a) an apparatus for editing an image in a mobile terminal; (b) a mobile terminal; (c) an application program; and (d) a storage medium.

According to one embodiment of the present invention, a method for editing an image comprises providing an interface for editing the image, in which both an image to be edited and at least one layout template icon corresponding to at least one layout template are displayed. In that interface, the layout template icon is displayed separated from the image to be edited with no overlap. The method also comprises receiving an instruction that indicates a user has selected a layout template through a layout template icon, and changing the layout of the image to be edited according to the selected layout template.

In this manner, the user can conveniently select a layout template to meet his or her requirements, thus enhancing the user experience.

According to one embodiment of the present invention, an apparatus for editing an image is provided which includes (a) a module configured to provide an interface for editing an image; (b) a display module configured to display the image and at least one layout template icon corresponding to at least one layout template, the layout template icon being displayed separated from the image with no overlap; (c) a receiving module configured to receive an instruction from a user that indicates selection of a layout template through the layout template icon; and (d) a layout updating module configured to change the layout of the image according to the selected layout template.

According to one embodiment of the present invention, a mobile terminal includes (a) a housing; (b) a processor; (c) a memory; (d) a circuit board; and (e) a power supply. The processor and the memory are both mounted on the circuit board, which is enclosed in the housing. In that embodiment, the power supply supplies power to the components of the mobile terminal. The memory stores executable program code. The processor reads and executes the executable program code stored in the memory to run a program that is configured to: (a) provide an interface for editing the image, in which both the image and at least one layout template icon corresponding to at least one layout template are displayed, the layout template icon being displayed separated from the image with no overlap; (b) receive an instruction that indicates a user has selected a layout template through the layout template icon; and (c) change the layout of the image according to the selected layout template.

According to one embodiment of the present invention, an application program is provided that runs on any suitable mobile terminal to carry out any of the above-described methods.

According to one embodiment of the present invention, a non-transitory storage medium is provided for storing an application program that runs on any suitable mobile terminal to carry out any of the above-described methods.

The present invention is better understood upon consideration of the detailed description below, in conjunction with the accompanying drawings.

### BRIEF DESCRIPTION OF THE DRAWINGS

FIG. 1 shows flow chart 100 for a method for editing an image, in accordance with one embodiment of the present invention.

FIG. 2 (a) shows six different schematic layout template icons, in accordance with one embodiment of the present invention.

FIG. 2 (b) shows a combined image resulting from placing individual images into a selected layout template, according to one embodiment of the present invention.

FIG. 3 shows a flow chart 300 for a method for editing an image, in accordance with one embodiment of the present invention.

FIG. 4 illustrates an interface for editing an image when a user selects a layout template icon, in accordance with the method of FIG. 3.

FIG. 5 illustrates an interface for editing an image when a user selects another layout template icon, in accordance with the method of FIG. 3

FIG. 6 shows apparatus 600 for editing an image, in accordance with an embodiment of the present invention.

FIG. 7 is a block diagram of mobile terminal 700, in accordance with one embodiment of the present invention.

### DETAILED DESCRIPTION OF THE PREFERRED EMBODIMENTS

Throughout this detailed description, the same or similar reference numerals denote the same or similar elements or features having the same or similar components. The embodiments described herein are provided merely to illustrate the present invention and should not be construed as limiting the present invention. In fact, numerous other changes, variations and modification within the scope of the present invention are possible. Unless otherwise expressly specified and limited, the terms “connected” and “coupled” are to be broadly construed to include fixedly connected, detachably attached to, integrally connected, mechanically connected, electrically connected, directly connected, or indirectly connected. Further, in this detailed description, unless otherwise specified, the term “multiple” means “two or more.”

The flow charts, methods, processes or procedures described herein are understood by those of ordinary skill in the art to be capable of being implemented by specific logical functions, or instructions in an executable code module. The steps of such methods, processes or procedures need not be carried out in the order shown or described. The present invention is applicable to mobile terminals that are based on, for example, such operating systems as the IOS operating system from Apple Computer, Inc., the Android operating system or other similar Linux-based operating systems, and the Windows Phone operating system from Microsoft Corporation. The present invention is also applicable to, without limitation, personal computers or other smart mobile devices. As referred herein, mobile terminals may include mobile telephones, tablet computers, personal digital assistants, notebook computers and various other devices.

FIG. 1 shows flow chart 100 for a method for editing an image, in accordance with one embodiment of the present invention. As shown in FIG. 1, at block S101, the method provides an interface for editing an image in which an image to be edited is displayed. The image may be provided, for example, in a mobile terminal. The image to be edited may be a combined image formed by combining two or more images retrieved from a storage medium provided in the mobile terminal, such as an SD (Secure Digital) Memory Card, or obtained from an image capturing device, such as a video camera, or image capturing software. Alternatively, the images may also be downloaded from a cloud server, or may be images shared by friends on the internet, such as images shared by friends on social website or applications.

At block S102, the method displays at least one layout template icon in the interface for editing an image. In this embodiment, each layout template icon corresponds to a layout template. The layout template icon displayed on the interface is displayed separated from the image to be edited. Both the image to be edited and the layout template icon are displayed on the interface with no overlap. If the user selects a layout template icon, the image to be edited is rearranged in real time according to the selected layout template icon. As the layout template icon and the image to be edited do not overlap in the interface, the user can view the changed layout in real time.

In this embodiment, a layout template icon can be a “thumbnail”¹ of the corresponding layout template, so that the user can visualize the layout template selected. ¹ A “thumbnail” refers to a miniaturized version of a larger image

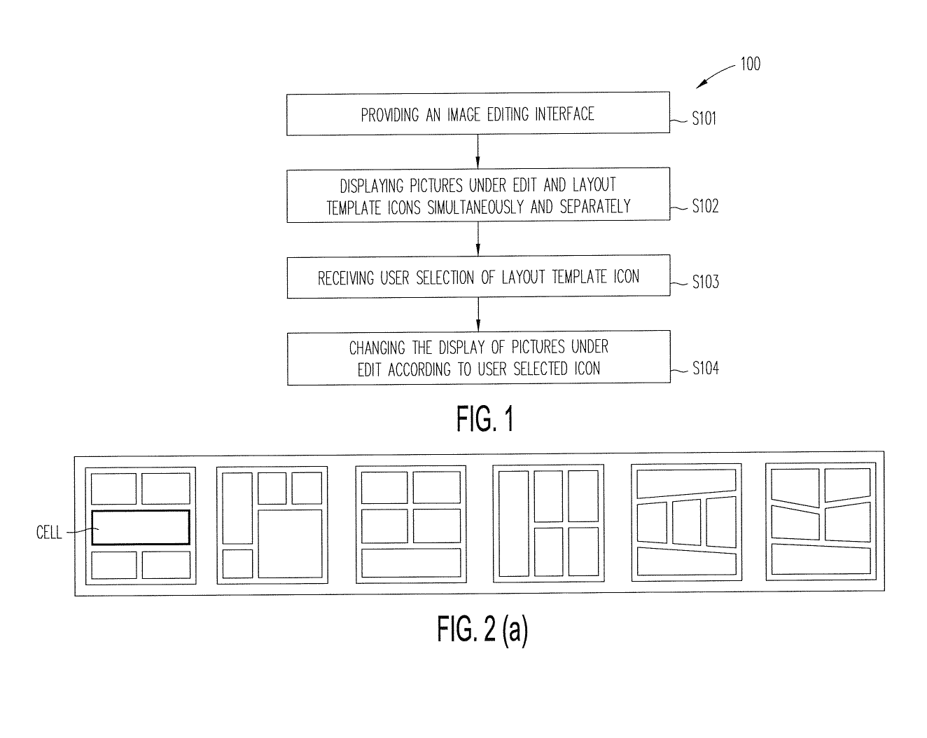

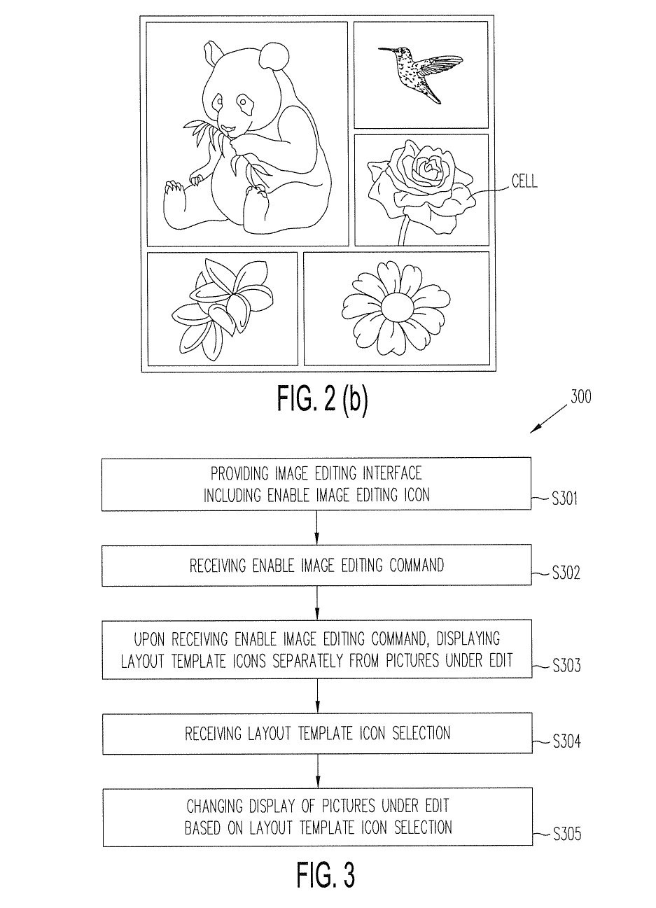

To provide variety, multiple layout templates may be stored in the mobile terminal. For example, FIG. 2 (a) shows six different layout template icons, each being a thumbnail of its corresponding layout template. FIG. 2 (b) is a schematic diagram of a combined image which is formed according to a selected layout template. As shown in FIGS. 2 (a) and 2 (b), each layout template may contain at least one cell, into which an image may be placed. Further, each layout template differs from another layout template by at least a size, a shape, a location of one cell. The combined image is formed according to a selected layout template by placing the images each into a cell in the selected layout template.

Note that the present invention is not limited by where one or more layout template icons are placed. For example, the layout template icons may be scattered around the image to be edited. In one embodiment of the present invention, the layout template icons are grouped together to be presented by a selection bar, so that a user may select the desired layout template by selecting the corresponding layout template icon from the selection bar. Preferably, the selection bar may be displayed below the image to be edited without overlapping.

Blocks S101 and S102 may be performed in any order, including simultaneously (e.g., providing the interface at the same time as displaying both the layout template icon and the image to be edited).

At block S103, the method receives an instruction that indicates that a user has selected a layout template through the layout template icon. If the user intends to edit the layout of the image displayed, the user may input an instruction in the mobile terminal to select a layout template. The present invention is not limited by the manner in which the instruction is input. In one embodiment, the instruction may be a touch operation, a vibrational motion, a rolling motion, a voice command, or any other suitable input method.

At block S104, the method changes the layout of the image to be edited according to the selected layout template.

In one embodiment, if the instruction is a touch operation, the selected layout template is the one corresponding to the layout template icon that the user touches. Accordingly, the layout of the image to be edited is changed to the layout represented by the layout template icon touched by the user. Thus, the user may view the selected layout of the image in real time.

Alternatively, if the instruction is a vibrational motion, a rolling motion, or a voice command, the selected layout template may be a random one or a predetermined one. For example, the selected layout template may be the next layout template icon in the order of presentation.

The combined image is formed by placing the images one by one into cells which positions, sizes and shapes are specified in the corresponding layout template.

According to the method for editing an image of the present invention, the layout template icon and an image to be edited may be displayed on the interface separately (i.e., without overlap). The user can easily change the layout of the image and view the effect of the change in real time. The convenience of this operation very effectively enhances the user experience.

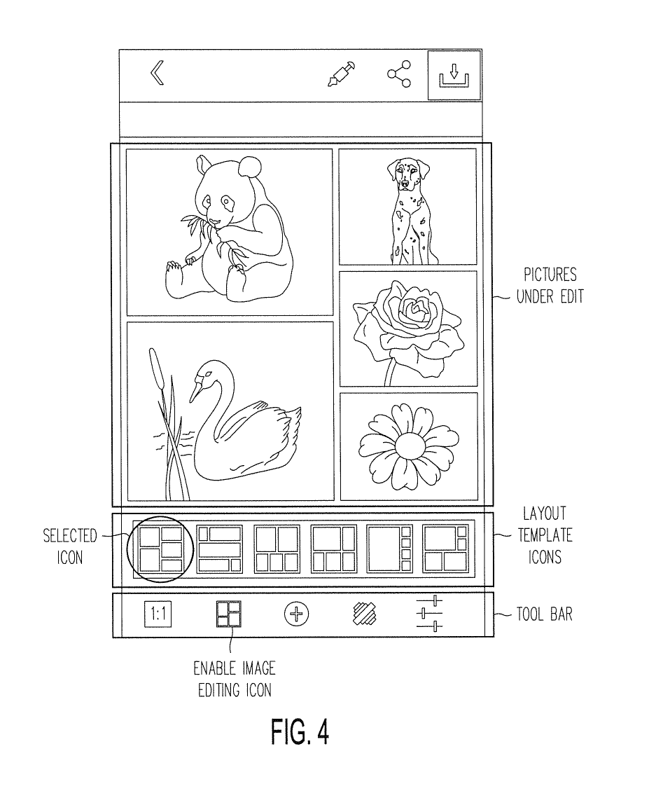

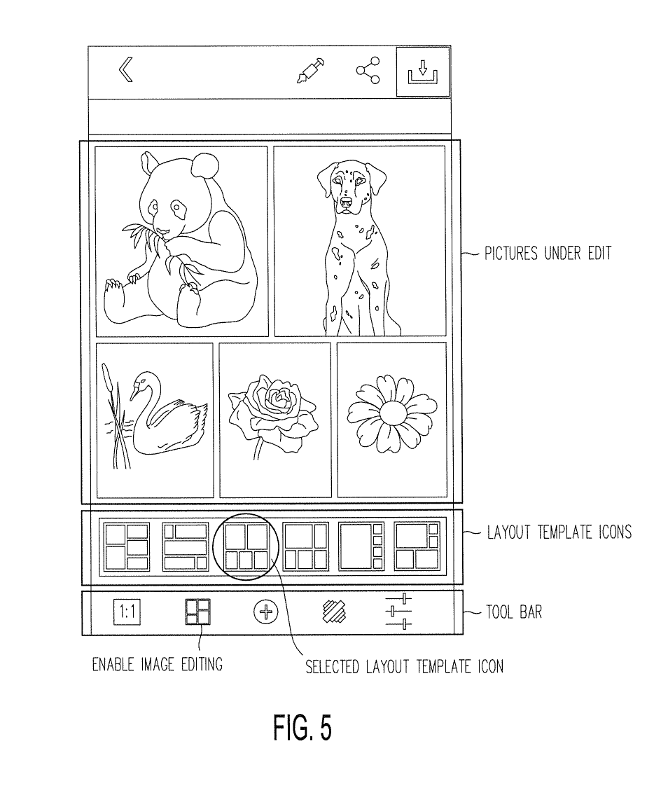

FIG. 3 shows flow chart 300 for a method for editing an image, in accordance with one embodiment of the present invention. FIGS. 4 and 5 illustrate the interface for editing the image according to the method shown in FIG. 3. In this embodiment, a tool bar is displayed in the interface and a layout editing icon is set in the tool bar. If the user clicks on the layout editing icon, indicating that he would like to edit an image, a layout template icon appears; otherwise, the layout template icon is hidden, which simplifies the interface. The method for editing the image of flow chart 300 is now described with reference to FIGS. 3-5.

As shown in FIG. 3, at block S301, the method provides an interface for editing an image, in which an image to be edited and a tool bar are displayed. Furthermore, a layout editing icon is set in the tool bar, and the image to be edited is displayed in a designated area.

At block 5302, the method receives an instruction for editing the layout triggered by the user clicking on the layout editing icon. For example, when a user desires to modify the layout of the image to be edited that is displayed on the interface, the user may click the layout editing icon in the tool bar so that the instruction for editing the layout can be triggered. Alternatively, the click may be a touch operation.

At block S303, the method displays at least one layout template icon according to the instruction for editing the layout. The layout template icon is displayed in the interface without overlapping the image to be edited. For example, when a user clicks on the layout editing icon, the layout template icon appears. In FIG. 4, six layout template icons are shown.

FIGS. 4 and 5 are merely exemplary of the image editing interface and should not be construed as limiting the manner in which the image editing interface may be provided. For example, in one embodiment, the content of the interface may be varied, the position of the toolbar may be varied (i.e., it is not necessary for the tool bar to be placed beneath the composite displayed), and the shape, size, pattern, and the number and function of the icons in the tool bar can all be varied, as needed. While the position of tool bar may be varied, the layout template icon in tool bar 352 do not overlap or occlude any portion of the region in which the image to be edited is displayed. In this embodiment, each layout template icon may be a thumbnail of the corresponding layout template. (Such a rendition is of course not limiting; each layout template icon may take any suitable form).

At block S304, the method receives an instruction which indicates that a user has selected a layout template through the layout template icon.

At block S305, the method changes the layout of the image to be edited according to the selected layout template. For example, when the user changes his/her selection of the layout template icon, the image to be edited is modified according to the modified selection, as shown in FIG. 5, where the user is shown to have selected the third layout template icon (from the left).

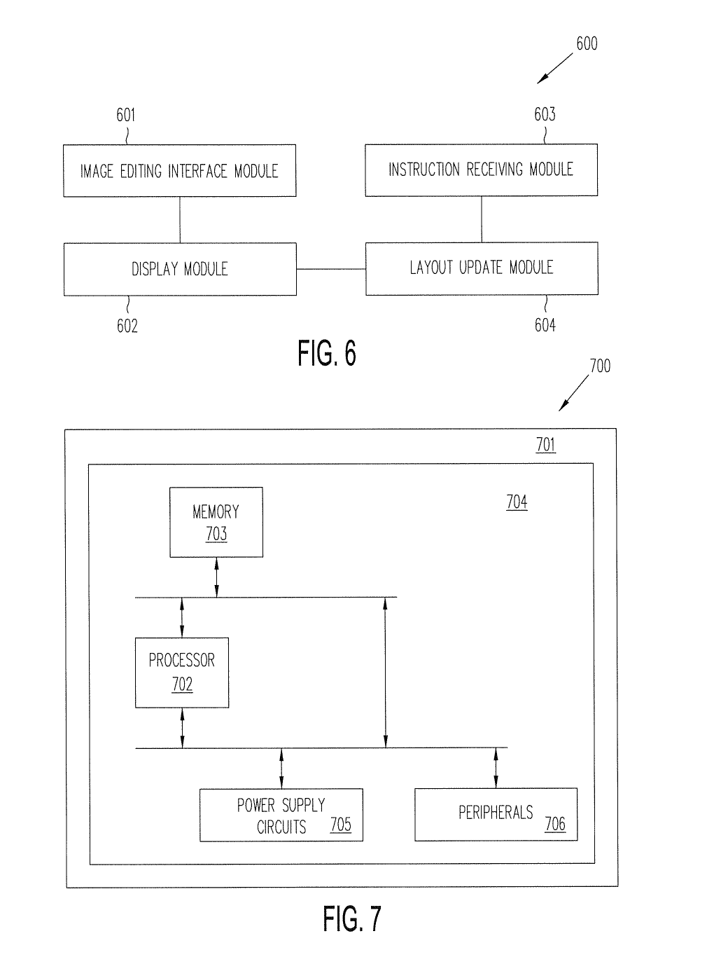

FIG. 6 shows an apparatus for editing an image, in accordance with embodiment of the present invention. As shown in FIG. 6, apparatus 600 includes image editing interface module 601, display module 602, instruction receiving module 603 and layout updating module 604.

Specifically, the image editing interface module 601 is configured to provide an interface for editing an image to be edited. In an embodiment of present invention, the interface may be provided according to a user's instruction. More specifically, the image to be edited may be a combined image consisting of at least two images. The images in the combined image may be images selected by the user from, for example, locally stored images (e.g., from an SD memory card), from an image capture device (e.g., a camera), or collected by software. Alternatively, the images may also be downloaded from a cloud server, or may be images shared by friends on the internet, such as images shared by friends on a social website or application.

Display module 602 is configured to display the image to be edited and at least one layout template icon in the interface. In one embodiment of the present invention, the image to be edited and the layout template icon are displayed separated from each other with no overlap, so that the layout template icon does not block or occlude the image to be edited. In one embodiment, the layout template icon may be a thumbnail of the corresponding layout template, so that the user may visualize the layout before a selection is made.

To provide diversity, a number of layout templates may be stored in a mobile terminal. Each layout template may contain one or more cells into which an image may be placed, with each cell differs from another cell in at least one aspect of: size, shape, location, number and arrangement. The present invention does not limit the manner in which the layout template icon may be provided.

In an embodiment of present invention, the layout template icons may be scattered around the image to be edited, or in a column next to the image to be edited, so long as the layout template icons are not shown to overlap or occlude the image to be edited.

The receiving module 603 is configured to receive an instruction which indicates that a user has selected a layout template through the layout template icon.

If the user desires to edit the layout of the displayed image, the user may input an instruction to the mobile terminal, such as by a touch operation, a vibration motion operation, a rotation motion operation, or a voice operation or any other suitable data input method.

The layout updating module 604 is configured to change the layout of the image according to the selected layout template. In one embodiment, when the instruction is a touch operation, the selected layout template is the corresponding layout template icon that the user touches. Accordingly, the layout of the image to be edited is changed to the selected layout template. Thus, the user may view the changed image in real time. Alternatively, if the instruction is a vibrational motion, a rolling motion, or a voice command, the selected layout template may be a random one or a predetermined one. For example, the selected layout template may be the next layout template icon in the order of presentation.

In an embodiment of present invention, display module 602 is further configured to display a tool bar in the interface. In that embodiment, a layout editing icon is set in the tool bar. Accordingly, receiving module 603 is configured to receive an instruction for editing the layout triggered by a user clicking on the layout editing icon.

As illustrated in FIGS. 4 and 5, a tool bar is displayed in the interface and a layout editing icon is set in the tool bar. If the user desires to edit an image and clicks on the layout editing icon, layout template icon appears; otherwise, the layout template icon is hidden, which simplifies the interface.

Each of these modules may be implemented, for example, in software (e.g. as an application program) to be executed on a processor of a mobile terminal, in conjunction with suitable peripheral devices.

FIG. 7 is a block diagram of a mobile terminal 700, in accordance with one embodiment of the present invention. As shown in FIG. 7, mobile terminal 700 includes: (a) housing 701, (b) processor 702, (c) memory 703, (d) circuit board 704, and (e) power supply 705.

In this embodiment, circuit board 704 is enclosed in housing 701. Processor 702 and memory 703 are mounted on circuit board 704 along with power supply 705, which is configured to supply power to the components of the mobile terminal. Memory 703 stores executable program code, which may be read and executed by processor 702. Such program code may be run to implement any of the methods discussed herein, or according to apparatus 600 of FIG. 6.

Such program code may also be provided on a non-transitory storage medium, from which the processor may load the application program into random access memory for execution.

Therefore, the various parts disclosed in the present disclosure may be implemented in hardware, software, firmware, or a combination thereof. For example, blocks or methods of the present invention can be embodied in memory as a suitable software or firmware implementation. Alternatively, an apparatus of the present invention can be implemented in hardware, as known to those of ordinary skill in the art, using one or more of the following techniques: customized logic circuits, application specific integrated circuits (ASICs), discrete logic circuits, and programmable logic circuits, including programmable gate arrays (PGAs), and field programmable gate arrays (FPGAs).

The above detailed description is provided to illustrate specific embodiments of the present invention and is not intended to be limiting. Numerous variations and modifications within the scope of the present invention are possible. The present invention is set forth in the accompanying claims below.

What is claimed is:

1. A method for editing an image, comprising:
providing an interface for editing an image in which an image to be edited is displayed;
displaying at least one layout template icon corresponding to at least one layout template in the interface; wherein the layout template icon is displayed separated from the image to be edited without overlap;
receiving an instruction which indicates that a user has selected a layout template through the displayed layout template icon; and
changing the layout of the image to be edited according to the selected layout template.

2. The method of claim 1, wherein the displaying at least one layout template icon corresponding to at least one layout template in the interface, the method further comprising:
receiving an instruction for editing the layout of the image to be edited triggered by a user clicking on a layout editing icon; and
displaying the layout template icon in the interface according to the instruction.

3. The method of claim 1, further comprising displaying a toolbar in the interface, and setting a layout editing icon in the tool bar.

4. The method of claim 1, wherein the layout template icon is displayed below the image to be edited.

5. The method of claim 1, wherein the instruction indicates that a user has selected a layout template through a layout template icon and wherein the instruction is provided by a touch operation, a vibration operation, a rotation operation, or a voice command.

6. The method of claim 1, wherein the layout template icon comprises a thumbnail of a corresponding layout template.

7. The method of claim 1, wherein the image to be edited comprises a combined image consisting of at least two images.

8. An apparatus for editing an image, comprising:
a providing module configured to provide an interface for editing an image;
a display module configured to display an image to be edited and at least one layout template icon corresponding to at least one layout template in the interface;
wherein the layout template icon is displayed separated from the image to be edited without overlapping;
a receiving module configured to receive an instruction which indicates that a user has selected a layout template through a layout template icon; and
a layout updating module configured to change the layout of the image to be edited according to the selected layout template.

9. The apparatus of claim 8, wherein the receiving module is further configured to receive an instruction for editing the layout of the image to be edited triggered by a user clicking on a layout editing icon, wherein the display module is further configured to display a tool bar in the interface, the layout editing icon being set in the tool bar, the method further comprising displaying the layout template icon in the interface according to the instruction for editing the layout of the image to be edited.

10. The apparatus of claim 8, wherein the layout template icon is displayed below the image to be edited.

11. The apparatus of claim 8, wherein the instruction which indicates that a user has selected a layout template through a layout template icon is triggered by a touch operation, a vibration operation, a rotation operation, or a voice command.

12. The apparatus of claim 8, wherein the layout template icon comprises a thumbnail of a corresponding layout template.

13. The apparatus of claim 8, wherein the image to be edited comprises a combined image consisting of at least two images.

14. A mobile terminal, comprising:
a housing;
a processor;
a memory;
a power supply for providing power to operate the mobile terminal; and
a circuit board enclosed in the housing on which the processor, the memory and the power supply are mounted, wherein the memory is configured to store program code executable by the processor which:
provides an interface for editing an image, in which an image to be edited is displayed;
displays at least one layout template icon corresponding to at least one layout template in the interface, wherein the layout template icon is displayed separated from the image to be edited without overlap;
receiving an instruction which indicates that a user has selected a layout template through a layout template icon; and
changing the layout of the image to be edited according to the selected layout template.

15. The mobile terminal of claim 14, wherein the processor is further configured to receive an instruction for editing the layout of the image to be edited triggered by a user clicking a layout editing icon; and to display the layout template icon in the interface.

16. The mobile terminal of claim 14, wherein a toolbar is displayed in the interface, and the layout editing icon is set in the tool bar.

17. The mobile terminal of claim 14, wherein the layout template icon is displayed below the image to be edited.

18. The mobile terminal of claim 14, wherein the instruction that a user has selected a layout template through a layout template icon is accomplished by a touch operation, a vibration operation, a rotation operation, or a voice command.

19. The mobile terminal of claim 18, wherein the layout template icon comprises a thumbnail of a corresponding layout template.

20. The mobile terminal of claim 14, wherein the image to be edited comprises a combined image consisting of at least two images.
